(19) United States
(12) Patent Application Publication
(10) Pub. No.: US 2026/0044597 A1
(43) Pub. Date: Feb. 12, 2026

(54) IDENTIFYING DEVIATIONS OF SYSTEM OR ENVIRONMENT

(71) Applicant: Kyndryl, Inc., New York, NY (US)

(72) Inventors: KALPESH SHARMA, BANGALORE (IN); HARIHARAN VENKITACHALAM, BENGALURU (IN); Veeresh Bushetti, Savanur (IN); Sudarshan Narayanan, Leander, TX (US)

(21) Appl. No.: 18/796,579

(22) Filed: Aug. 7, 2024

(51) Int. Cl. G06F 21/55; G06F 21/56

(52) U.S. Cl. CPC G06F 21/552; G06F 21/566

(57) ABSTRACT

A computer-implemented method including: collecting, by a computing device, specification documentation of a product and drift data of the product during a product lifecycle; analyzing, by the computing device, the specification documentation and the drift data of the product to identify anomalies between the specification documentation and the drift data of the product during different stages of the product lifecycle; computing, by the computing device, a score of each of the identified anomalies; recommending, by the computing device, solutions to fix selected anomalies based on their score and by using content-based recommendations; and displaying the recommended solutions to an end-user in a dashboard.

### BACKGROUND

Aspects of the present invention relate generally to identifying deviations (e.g., drifts) in a DevSecOps cycle and, more particularly, to a system, method and computer program product which identifies deviation of a system or environment from its intended or desired state.

In the fast-paced world of modern software development, DevSecOps methodologies have become indispensable in ensuring seamless collaboration between development and operations teams. The DevSecOps methodologies can help identify deviations that occur throughout the DevSecOps cycle from coding to deployment, leading to potential inefficiencies, errors, delays, etc. The DevSecOps methodologies these deviations are addressed in real time to identify the potential inefficiencies, errors, etc. in all phases of software development.

### SUMMARY

In a first aspect of the invention, there is a computer-implemented method including: collecting, by a computing device, specification documentation of a product and drift data of the product during a product lifecycle; analyzing, by the computing device, the specification documentation and the drift data of the product to identify anomalies between the specification documentation and the drift data of the product during different stages of the product lifecycle; computing, by the computing device, a score of each of the identified anomalies; recommending, by the computing device, solutions to fix selected anomalies based on their score using content-based recommendations; and displaying the recommended solutions to an end-user in a dashboard.

In another aspect of the invention, there is a computer program product including one or more computer readable storage media having program instructions collectively stored on the one or more computer readable storage media. The program instructions are executable to: collect specifications of a product through technical documentations; collect data of the product from different probes used throughout a product lifecycle of the product; identify anomalies in the data based on a comparison between the data and the specifications; prioritize the anomalies by assigning a risk score to each of the identified anomalies; blocking selected anomalies based on the assigned risk score and unblock other selected anomalies based on the assigned risk score; provide a recommended solution to address the selected anomalies; and provided the recommended solution to a user on a dashboard.

In another aspect of the invention, there is system including a processor, a computer readable memory, one or more computer readable storage media, and program instructions collectively stored on the one or more computer readable storage media. The program instructions are executable to: collect specification documentation of a product and specification data of the product during a product lifecycle; analyze the specification documentation and the specification data of the product to identify anomalies in the product at different stages of the product lifecycle; compute a risk score of each of the identified anomalies; recommend solutions to fix selected anomalies based on their risk score and by using content-based recommendations; and display the recommended solutions to an end-user in a dashboard.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an exemplary environment in accordance with aspects of the invention.

FIG. 5 shows different components/engines of or associated with a DriftOps module of FIG. 4 in more detail in accordance with aspects of the present invention.

FIG. 6 shows a flowchart of a dynamic drift gate process in accordance with aspects of the present invention.

FIGS. 7A and 7 B show a detailed approach in accordance with aspects of the present invention.

### DETAILED DESCRIPTION

Aspects of the present invention relate generally to identifying deviations (e.g., drifts) in a DevSecOps cycle and, more particularly, to a system, method and computer program product which identifies deviations of a system or environment from its intended or desired state. The system or environment includes, for example, software and hardware systems and environments. In aspects of the invention, the system, method and computer program product identify deviations of software and/or hardware systems and environments from their intended or desired state and defines and/or raises dynamic gates per drift-analysis. It should be understood by one of skill in the art that a gate is a condition that determines whether an application, e.g., software, hardware, etc., can run in a particular environment. In embodiments, a gate condition may be, for example, a rule.

In more specific aspects of the present invention, the system, method and computer program product identify deviations that arise during the various stages of a software development lifecycle, including coding, testing, building, deployment, and monitoring. More specifically, the deviations (e.g., drifts) which are identified, documented, categorized and analyzed by the system, method and computer program product include, amongst others:
(i) added APIs which are prone to database leakages;
(ii) missed test cases in a regression cycle;
(iii) unauthorized commits;
(iv) incorrectly updated or changed production configuration to software and/or hardware made ad-hoc, without being recorded or tracked;
(v) incorrect version of code deployed into higher environments; and/or
(vi) corrupted data modifications or data.

In this manner, the system, method and computer program product addresses challenges posed by deviations in a DevSecOps pipeline. These deviations, also known as drifts, are often unintentional and happen when undocumented or unapproved changes are made to software, hardware and/or operating systems, which have an impact on system performance and security. Accordingly, the system, method and computer program product provide a robust and reliable DevSecOps pipeline, which can identify drifts, enhance software development efficiency, minimize deployment risks, and ultimately deliver superior products to end-users. Drifts and deviations are used interchangeably herein.

The system, method and computer program product provide a technical feature (e.g., technical solution) to a technical problem and a practical application of identifying and correcting deviations or drifts in software and hardware systems and environments. The system, method and computer program product, for example, identifies the deviations, categorizes the deviations, analyzes the deviations for their impact on overall software quality, release cycles, and user experience, and provides recommendations for correcting such deviations. Hence, from a technical solution which provides a practical application, the system, method and computer program product provides an analytical platform with an ability observe an entire system (S-SDLC) for any potential drifts in a software development lifecycle or DevSecOps environment, scoping the entire inspection from specification, definition, detection, risk scoring and remediation of a drift (e.g., deviation), and thus creating a knowledge base to manage drift-operations.

In this way, the system, method and computer program overcome deficiencies in existing approaches in DevSecOps as further described herein. By way of an example, existing approaches to DevSecOps are manual in nature and prone to mistakes, errors and/or oversights from the DevSecOps team. Illustratively, a developer may miss coding standards during development or use the deprecated or vulnerable library versions. Other issues that may arise include: (i) code being deployed into a higher environment which bypasses downstream environments, (ii) ad-hoc updates to configurations which lead to misconfigurations or (iii) manual database updates which lead to data corruption. Known tools designed to identify these issues have many of their own shortcomings including, but not limited to: (i) providing false alerts or missing real issues; (ii) each tool only monitors a specific area, leaving blind spots; (iii) tools slow down the system if not set up correctly; (iv) limited support for different programming languages; and (v) predefined configurations which miss critical deviations. In contrast, the the system, method and computer program provide a fully integrated platform to identify, categorize and address all issues encountered during the lifecycle of product development.

It should be understood that, to the extent implementations of the invention collect, store, or employ personal information provided by, or obtained from, individuals (for example, DevSecOps or end-users), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

### Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

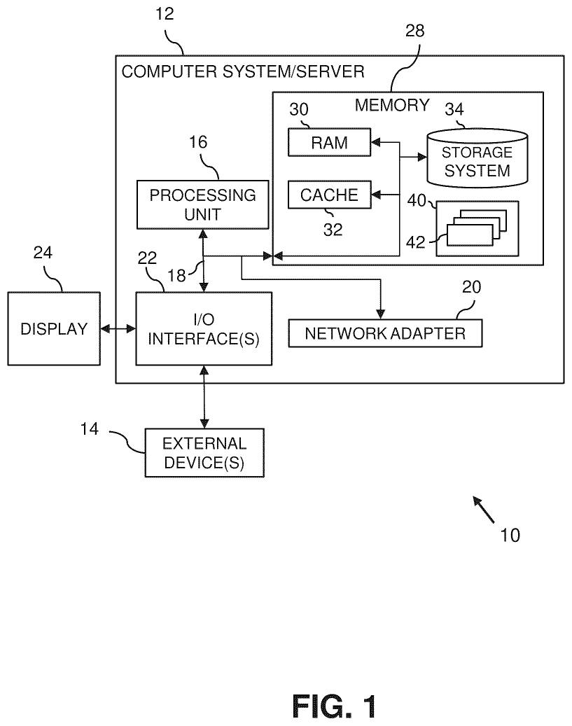

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

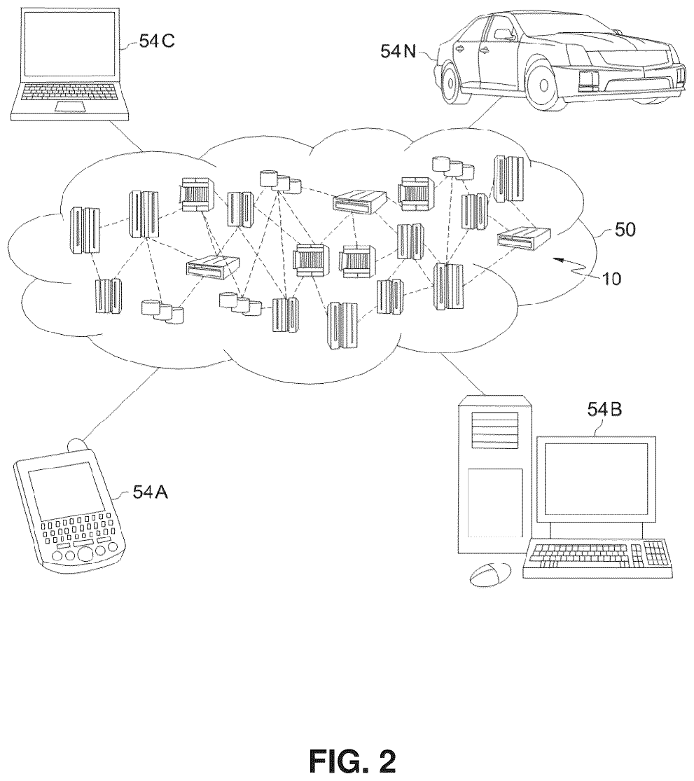

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

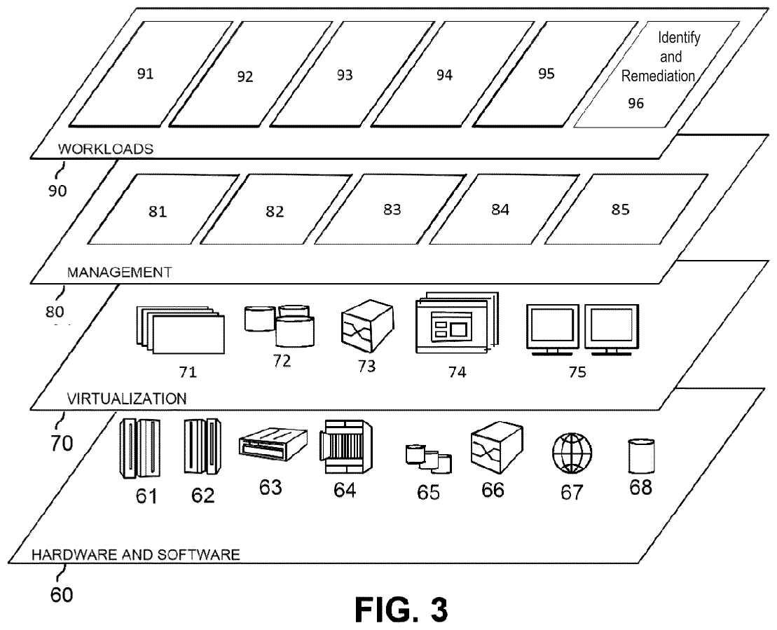

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and identify and remediation 96. The identify and remediation 96 can identify, categorize, score and remediate issues during the product lifecycle.

Implementations of the invention may include a computer system/server 12 of FIG. 1 in which one or more of the program modules 42 are configured to perform (or cause the computer system/server 12 to perform) one of more functions of the identify and remediation 96 of FIG. 3. For example, the one or more of the program modules 42 may be configured to provide the following technical features in a practical application:
(i) collect drift specifications through product requirements and other sources of technical documentations, and process the content with co-relation on a drift specification database;
(ii) identify anomalies towards any drifts by keeping the drift specification as a reference point and compare the drifts against the change audit records;
(iii) prioritize the drifts, associating it with a risk score to narrow down the drifts for false positives and, hence, take actions for remediation;
(iv) collect drift content across diverse operational sources/systems through pre-integrated drift probes (e.g., through use of known tools), and process the content with co-relation onto a change audit database; and
(v) define and build dynamic drift gates to manage drift operations to minimize risk associated to a service availability.

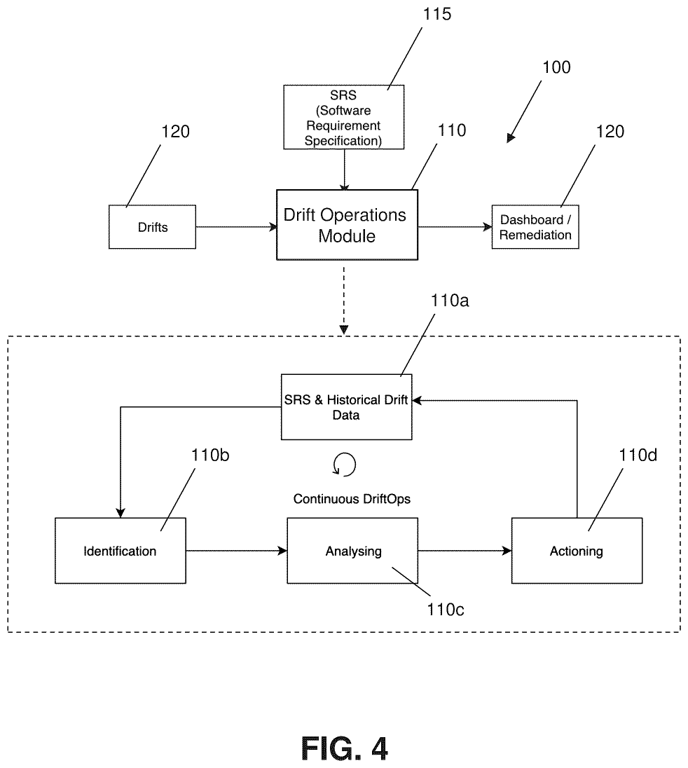

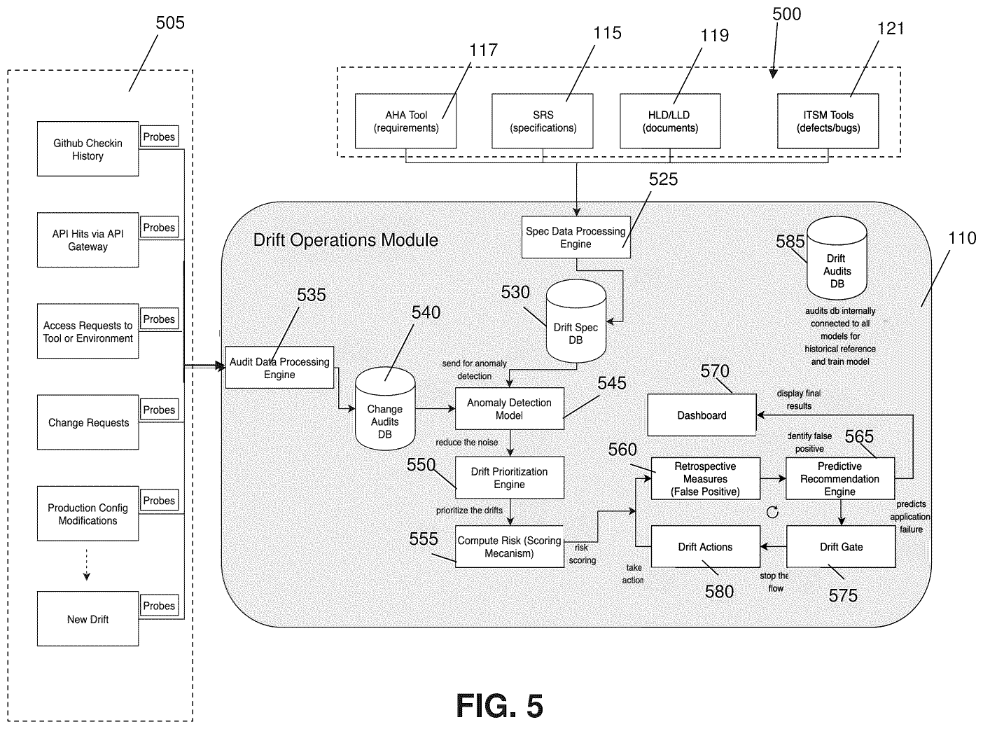

FIG. 4 shows a block diagram of an exemplary environment 100 in accordance with aspects of the invention. In embodiments, the environment 100 includes a drift operations (DriftOps) module 110 that receives and/or obtains software requirement specifications (SRS) 115 and drifts or deviations 120 obtained from tools used during the build process of a software or hardware product during DevSecOps. In embodiments, the software requirement specifications (SRS) are a set of product requirements and technical documentations used to implement and/or build a software/hardware project. As further described with respect to FIG. 5, the product requirements and technical documentations can come from many different sources such as AHA management tool requirements, high level design (HLD)/low level design (LLD) documentation and IT service management (ITSM) documentation. The drifts are deviations that have occurred during a DevSecOps cycle as already described herein. The DriftOps module 110 compares and/or analyzes the documentation of the SRS 115 and the drifts or deviations 120 to determine a remediation which is provided in a dashboard 125.

In embodiments, the DriftOps module 110 comprises a database 110a, an identification module 110b, an analyzing module 110c and an actioning module 110d, each of which may comprise one or more program modules such as program modules 42 described with respect to FIG. 1. The DriftOps module 110 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

In aspects of the invention, the database 110a obtains and/or stores the documentation of the software requirement specifications (SRS) in addition to historical drift data and remedial actions taken with respect to the historical drift data. The database 110a may include additional documentation as described with respect to FIG. 5. The historical drift data may be deviations obtained from a current software/hardware development cycle and/or past software/hardware development cycles, used to analyze current situations in the DevSecOps lifecycle. The identification module 110b identifies potential deviations or drifts obtained from the build process of a software or hardware product during a current DevSecOps lifecycle. The identification module 110b may obtain drift information from probes used in different tool sets known in the art.

In the analyzing module 110c, the deviations or drifts may be analyzed with respect to the documentation of the software requirement specifications (SRS) in addition to historical drift data. In this way, any current deviations or drifts may be identified as requiring an appropriate action. The analyzing module 110b may also categorize the deviations or drifts, compute risk scoring, etc. as further described herein. The actioning module 110d will provide certain actions to take to remedy the deviations or drifts. The actioning module 110d will provide the remedial action to the database 110 for referral with respect to other identified deviations.

FIG. 5 shows different components/engines of or associated with the DriftOps module 110 of FIG. 4 in more detail in accordance with aspects of the present invention. It should be understood by those of skill in the art that some of the components/engines described herein may be or separate engines or components integrated into a single module of the DriftOps module 110 (as depicted herein) or may be stand-alone components that feed information into the DriftOps module 110. For example, the different engines 525, 535 and databases 530, 540, 585 may be stand-alone components or integrated directly into the DriftOps module 110. FIG. 5 can also be a flowchart of an exemplary method in accordance with aspects of the present invention. Steps of the method may be carried out in the environment of FIG. 4 and utilizing the computing infrastructure of FIG. 1.

In embodiments, the DriftOps module 110 receives and/or obtains documentation from the different sources 500 and different tools 510. The sources 500 may include, amongst others, the SRS documentation 115, in addition to AHA management tool requirements 117, high level design (HLD)/low level design (LLD) documentation 119 and IT service management (ITSM) documentation (e.g., defects/bugs) 121. The information from different the tools 510 may include, for example, Gitbhub checkin history, API hits via API gateway, access requests to tolls or environment, change requests, production modifications and new drifts from production modifications. The information of the different tools can be obtained by use of monitoring probes or agents to spot any changes in the applications (e.g., GitHub code check-in, configuration changes, API access, etc.).

As should be known to those of skill in the art, the AHA management tool requirements serve as a roadmap and project planning software documentation designed to help teams define their strategy and manage product development projects. Moreover, as should be understood by those of skill in the art, HLD documentation is the first step in the design process and provides a broad overview of the software architecture which describes main components of the system and their interactions, etc.; whereas LLD documentation provides a more detailed, technical representation of the system, defining the specific data structures and algorithms that will be used, as well as the interfaces between the components of the system. The ITSM documentation enables IT operations organizations to support the product environment.

In embodiments, the information from the different sources 500 may be obtained by a specification data processing engine 525 and stored in a drift specification database 530. In embodiments, the database 530 may normalize the data. For example, the database 530 will correlate all the specification data in accordance with “Epic” or “Feature”, which will serve as a reference for drift validation. As should be understood by those of skill in the art, “Epic” is broken down into smaller, more manageable pieces, known as user stories or features. A “Feature”, on the other hand, is a smaller, more specific piece of functionality that can be completed in a single development cycle or iteration. Features are often derived from Epics and are more granular than Epic.

Similarly, the information from different the tools 510 may be obtained by an audit data processing engine 535 and stored in a database 540. The database 530 may normalize the data. The audit data processing engine 535 correlates all the audit data with “Story” or “Task”. As should be understood by those of skill in the art, “Stories” provide the context and understanding necessary to know what work needs to be done and are the key to understanding the customer; whereas “Tasks” provide a way to break that work down into manageable pieces that can be completed in a reasonable amount of time. By way of example, for all GitHub commits based on the comments, “Story” or “Task” will be identified and group all the changes, similarly for all any change requests and product configuration modifications which will have business justifications.

The information stored in the databases 530, 540 may be fed to an anomaly detection model 545. In embodiments, the anomaly detection model 545 uses all information obtained by different sources and different tools to provide an aggregate analysis of these sources and tools, which will flow through additional engines and process flows in accordance with aspects of the invention. In this way, the DriftOps module 110 can provide a fully integrated analysis of all known drifts and specification documentations, comparing them to historical data and providing a remediation as described herein.

For example, the anomaly detection model 545 identifies significant deviations from the expected behaviour. In aspects of the invention, as change in audit data can be extensive, the anomaly detection model 545 can focus on identifying only significant drifts by analysing it against the requirements and specifications, also reducing noise. Also, the anomaly detection model 545, in embodiments, uses statistical measures, e.g., standard deviations, to set thresholds for significant deviations. The anomaly detection model 545 can implement different algorithms to provide the features described herein. For example, the anomaly detection model 545 can implement a Decision Tree algorithm including, for example, an Isolation Forest algorithm by using random forest or decision tree for efficient anomaly detection in large change audit datasets. In embodiments, the Isolation Forest is an unsupervised machine learning algorithm for anomaly detection that identifies anomalies by isolating outliers in the data.

The information from the anomaly detection model 545 is sent to the drift prioritization engine 550. The drift prioritization engine 550 reduces noise by ranking the identified drifts based on their potential impact and severity. The prioritized drift information is sent to the risk score engine 555. The risk score engine 555 assesses the risks associated with the identified drifts using a scoring mechanism by applying, for example, various test suits such as regression analysis, performance testing, load testing, etc. to identify the percentage of failure rate against the specification data (documentation). In embodiments, a higher failure rate means higher risk. By way of illustrative non-limiting example, the threshold limits (configurable parameters) can be defined as:
50% to 100%-High;
20% to 50%-Medium; and
0% to 20%-Low.

The risk scores that have now been calculated based on information of many different tools and different sources is fed to a retrospective measure engine 560. The retrospective measure engine 560 reviews the results from the risk score engine 555 and checks for false positives. For example, any of the audit's data found to be matching with specification documentation requirement or having low risk can be considered as false positive.

Based the risk assessment and scoring, the positive drifts or deviations are provided to the predictive recommendation engine 565. The predictive recommendation engine 565 will predict the overall health of an application and recommend the solutions/possible fixes. In aspects of the invention, the predictive recommendation engine 565 uses Linear Regression with a content-based recommender system to provide recommended steps or action the user needs to take in the event of a drift. The content-based recommender system suggests items to users based on their preferences and the features of items. For example, the content-based recommender system analyzes the content of items and matches them with user profiles.

This information is fed to a dashboard 570 for visualization and accessibility to end-users. The information from the predictive recommendation engine 565 is also feed to a drift gate engine 575. The drift gate engine 575 can act a gatekeeper to stop the flow based on the prediction and scoring. The drift gate engine 575 can also pass the information from the predictive recommendation engine 565 to the drift action engine 580. In embodiments, the drift action engine 580 can take the necessary actions based on recommendations. It should be understood by those of skill in the art, that the flow of 560, 565, 575 and 580 is an iterative process. For example, the necessary actions based on recommendations can be fed back to the retrospective measure engine 560 to determine if the actions taken will now trigger a false positive. If not, the process will continue to the predictive recommendation engine 565.

FIG. 5 also shows an audits database 585. The database 585 serves as a historical reference and used to train the models for improved performance over time.

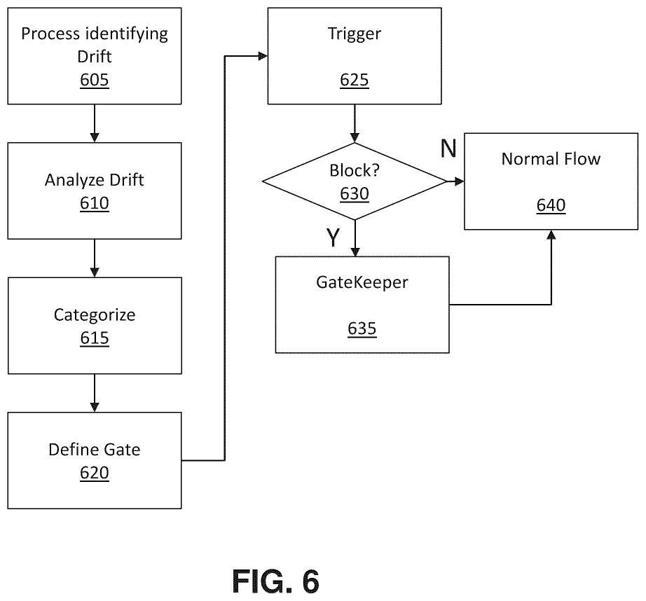

FIG. 6 shows a flowchart of a dynamic drift gate process in accordance with aspects of the present invention. The steps of the method may be carried out in the environment of FIGS. 4 and 5 and utilizing the computing infrastructure of FIG. 1. At step 605, drifts or deviations in the product, e.g., software and/or hardware, are identified as described herein. At step 610, the drifts are analyzed as already described herein, e.g., identified, correlated, etc. At step 615, the drifts are categorized and scored based on, for example, high risk, medium risk and low risk as described herein. At step 620, dynamic drift gates are defined, e.g., control points to accommodate a pipeline. In more specific aspects of the present invention, the dynamic gates are defined and built to manage drift operations to minimize risk associated to a service availability, i.e., product. As should be understood by those of skill in the art, a gate is a condition that determines whether an application can run in an environment. A gate condition may, accordingly, be a rule. A pipeline can have some environments with and without gates.

At step 625, a trigger is automatically set to route the deviation through the gate. At step 630, a deviation can be blocked or unblocked, as also shown in the exemplary below Table 1. If there is a block, the gatekeepers provide intervention/remediation to the deviation as shown in the exemplary below Table 1 at step 635. The workflow can continue at step 640. If there is no block, the normal workflow can continue at step 640.

TABLE 1
Dynamic gates (can be configured for additional roles)

| Drift | | | |
|---|---|---|---|
| categorisation | Severity | Dynamic Gate | Action |
| Sec & Comp | H-M | Sec Architect | Blocking |
| Unit test gaps | M-L | QA Leader | Non blocking |
| Feature gaps | H-M | Product | Blocking |
| | | Manager | |
| New IaaC | M-L | Ops Manager | Non blocking |

In the example Table 1, different drift categorizations and their respective severities, e.g., scores are shown. The table also defines the different dynamic gates and respective actions that are to be taken, e.g., block or not block the drift (e.g., deviation).

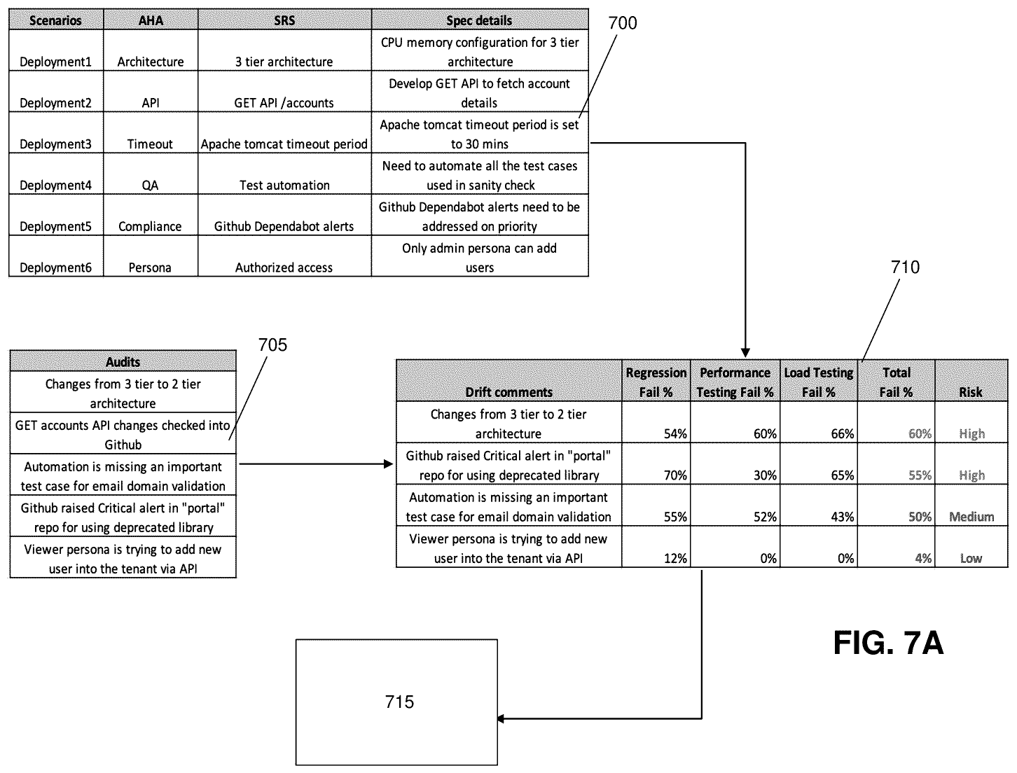

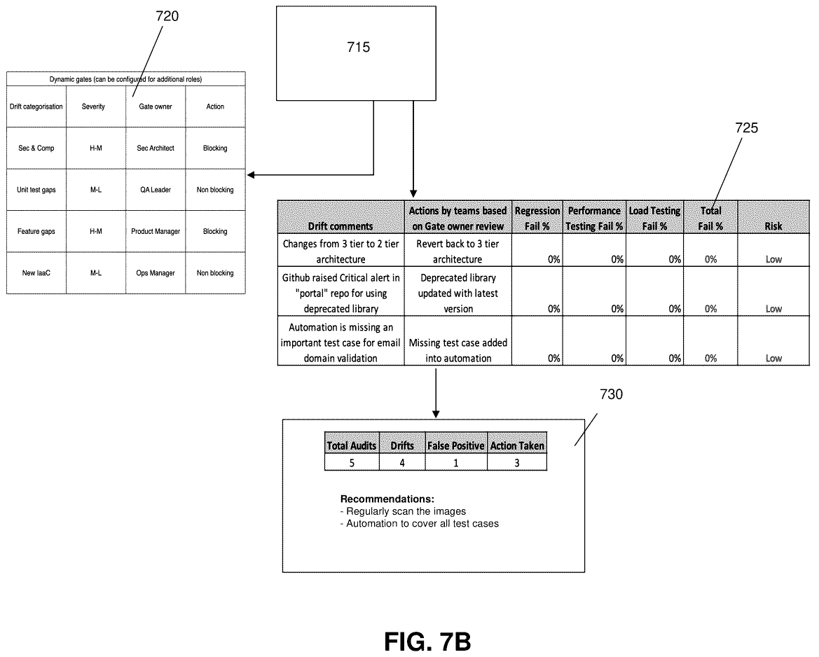

FIGS. 7A and 7 B a detailed approach in accordance with aspects of the present invention. For example, FIGS. 7A and 7 B shows a plurality of specifications 700 and audits from different tools 705 that may be implemented with the DevSecOps module as described herein. In this non-limited illustrative example, the specifications 700 may be for different deployments, e.g., deployument1-deployument6. The deployments may include documentations from AHA, SRS and specification details as noted in the specifications 700 and already described herein. The audits 705 may be deviations found by the probes of the different tools as already described herein. As shown in box 710, the audits are compared against the requirement specifications and noise reduction is done performed, e.g., (GET API related drift is removed), then prioritized and risk calculated based on the test output as described with respect to FIG. 5. For example, a drift comment “change from 3 tier to 2 tier” may have a regression fail of 54%, a performance testing fail of 60%, a load testing fail of 66% and an overall total fail of 60%, with the overall total fail being an average of the other fails. A risk score can be assigned based on the average fail. E.g., High, Medium and Low.

The results shown at box 710 are passed to the dynamic drift gate 715. At this stage, false positive scenarios are removed and High and Medium risk items are stopped by the dynamic drift gate 715 for intervention. And, as shown in box 720, based on the drift categorization and severity different gate owners are identified so that they can intervene to make decisions or instruct respective teams to fix relevant issues. These decisions or instructions are shown in box 725. As this is an iterative process, the regression, performance and load testing can be reevaluated. These decisions or instructions may also be automated. The results can be provided at dashboard 730. For example, the dashboard 730 shows the overall results and based on overall drift assessment gives recommendations.

In view of the above, it is now possible to proactively address drifts or deviations in the software lifecycle ranging from minor issues to catastrophic failures, thus significantly reducing or eliminating significant damage and loss of business and ensuring superior product development and increased customer satisfaction. For example, and advantageously, by implementing aspects of the present invention:
(i) drifting data which can lead to inaccurate predictions, resulting in lower sales and customer dissatisfaction are identified and remedied;
(ii) misconfigured cloud settings which can cause security breaches, data leaks, and service interruptions are identified and remedied; and
(iii) outdated dependencies which can result in software vulnerabilities, performance issues, and failures are identified and remedied.

In this way, it is possible to mitigate drifts proactively by continuous monitoring, automated testing, and regular updates to ensure that software, infrastructure, and machine learning models remain robust, secure, and aligned with business objectives.

### Example Use Case 1

Consider a business-critical application which handles multiples clients. Changes to any small configuration in production that may be incorrect will lead to a large impact to customers. Accordingly, it is necessary to restrict unauthorized access and to achieve immutability for production configurations. The implementation of a controlled process is necessary where any configuration changes require approval before reflecting in the production environment. This safeguard against drift will ensure that only authorized and vetted modifications are applied to the production setup. One such example is where production config file got changed and it is not matching with the specifications. In implementing aspects of the invention, the production config file will be identified, analysed, scored and passed for remediation by a security architect.

### Example Use Case 2

Consider an infrastructure-critical application which manages multiples infrastructures at a customer cloud/data center using terraform to perform Day 1 and Day2 procedures. Without a predictive recommendation layer, the drift on the Day2 flow where the operator needs to decide whether to accept the drifts and apply the change would require guess work. In implementing aspects of the invention, the drift can be identified, and the operator can be provided with an understanding whether to accept the changes and roll this out on the infrastructure. Using the predictive recommender system helps in making recommended decision that are present to the operator who can approve and take it forward on the rollout.

### Example Use Case 3

Usage of the predictive recommendation modelling into the drift gate as described herein helps identify false positives in the differences detected between the current system data to the requested change data area. Also, the recommendation system as described herein assists with the information filtering obtained in the drift outcome. A linear regression algorithm on the incoming data set can be used. The linear regression algorithm, for example, uses the historically rated information for similar outcomes and using the ratings as described herein, the system., method and computer program product of the present invention provides recommendation to address the drift.

Along with the liner regression algorithm, it is also contemplated to use a recommender system in content-based methods as is known in the art. In the content based when there are drift outcomes, it compares the drift outcomes to the historic drift data to determine what sections match using the linear regression algorithm and recommends an outcome on what decision the user can take on the current drift.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
collecting, by a computing device, specification documentation of a product and drift data of the product during a product lifecycle;
analyzing, by the computing device, the specification documentation and the drift data of the product to identify anomalies between the specification documentation and the drift data of the product during different stages of the product lifecycle;
computing, by the computing device, a score of the identified anomalies;
recommending, by the computing device, solutions to fix selected anomalies based on their score and by using content-based recommendations; and
displaying the recommended solutions to an end-user in a dashboard.

2. The method of claim 1, wherein the computing of the score of the anomalies prioritizes the identified anomalies comprising a high risk score, a medium risk score and a low risk score and the recommended solution of the anomalies is for the high risk score and the medium risk score.

3. The method of claim 2, further comprising taking action to fix the selected anomalies using the recommended solutions.

4. The method of claim 2, further comprising checking the anomalies, by the computing device, for false positives prior to providing the recommended solutions.

5. The method of claim 2, wherein the taking action to fix the selected anomalies is further analyzed, by the computing device, against the specification documentation to identify any further anomalies caused by the action taken and when the further anomalies are identified, computing, by the computing device, a score of the further anomalies.

6. The method of claim 1, further comprising feeding the recommended solution to a drift gate, which acts as a gatekeeper to stop a flow of work.

7. The method of claim 6, further identifying, by the computing device, an owner that can attend to the anomalies within the product at a particular point in the lifecycle.

8. The method of claim 1, wherein the content-based recommendations are provided by a content-based recommender system and regression analysis that suggests the recommended solutions to users.

9. The method of claim 1, wherein the drift data of the product are obtained by different probes during different stages of the lifecycle of the product and are aggregated together for the analyzing the identified anomalies between the specification documentation and the drift data to provide an analytical platform with an ability observe an entire system for any potential drifts in a software development lifecycle or DevSecOps environment, scoping an inspection from the specification documentation including a definition, a detection of the identified anomalies, the score and the solutions to fix the selected anomalies to create a knowledge base to manage drift operations.

10. The method of claim 1, wherein:
the specification documentation are provided from different specification documents;
the specification documentation is stored and normalized within a documentation database;
the drift data is provided by pre-integration of different probes across diverse operational sources at different stages of the product lifecycle and processing the drift data with co-relation on to an audit database; and
the drift data is normalized is stored and normalized within a drift database.

11. The method of claim 1, further comprising storing audit data in an audit database which serves as a historical reference and is used to train models for improved performance over time.

12. The method of claim 1, wherein the score assesses risks associated with identified drifts using at least one of regression analysis, performance testing, load testing, and performance testing to identify a percentage of failure rate against the specification documentation.

13. The method of claim 1, wherein the collecting of the drift specifications comprising collecting the drift specifications through product requirements and sources of technical documentations, and further comprising processing the content with co-relation on a drift specification database.

14. A computer program product comprising one or more computer readable storage media having program instructions collectively stored on the one or more computer readable storage media, the program instructions executable to:
collect specifications of a product through technical documentations;
collect data of the product from different probes used throughout a product lifecycle of the product;
identify anomalies in the data based on a comparison between the data and the specifications;
prioritize the anomalies by assigning a risk score of the identified anomalies;
blocking selected anomalies based on the assigned risk score and unblock other selected anomalies based on the assigned risk score;
provide a recommended solution to address the selected anomalies; and
provide the recommended solution to a user on a dashboard.

15. The computer program product of claim 14, wherein the anomalies are identified by an unsupervised machine learning model and the identified anomalies comprise at least one of: added APIs which are prone to database leakages; missed test cases in a regression cycle; unauthorized commits; incorrectly updated or changed production configuration to software and/or hardware made ad-hoc, without being recorded or tracked; incorrect version of code deployed into higher environments; and corrupted data modifications or data.

16. The computer program product of claim 14, wherein the data of the product from different probes are categorized prior to providing the recommended solution.

17. The computer program product of claim 14, further comprising defining and building dynamic drift gates to manage drift operations to minimize risk of product failure.

18. The computer program product of claim 14, wherein the risk score is based on an at least one of a regression fail percentage, performing testing fail percentage, and load testing fail percentage.

19. A system comprising:
a processor, a computer readable memory, one or more computer readable storage media, and program instructions collectively stored on the one or more computer readable storage media, the program instructions executable to:
collect specification documentation of a product and specification data of the product during a product lifecycle;
analyze the specification documentation and the specification data of the product to identify anomalies in the product at different stages of the product lifecycle;
compute a risk score of the identified anomalies;
recommend solutions to fix selected anomalies based on their risk score and by using content-based recommendations; and
display the recommended solutions to an end-user in a dashboard.

20. The system of claim 19, wherein the risk score is based on a regression fail percentage, performing testing fail percentage, and load testing fail percentage.
